(19) United States
(12) Patent Application Publication
(10) Pub. No.: US 2014/0183965 A1
(43) Pub. Date: Jul. 3, 2014

(54) ELECTRONIC COMPONENT, POWER FEEDING DEVICE, AND POWER FEEDING SYSTEM

(71) Applicant: SEIKO INSTRUMENTS INC., Chiba (JP)

(72) Inventor: Norihiro OKAZAKI, Chiba (JP)

(73) Assignee: SEIKO INSTRUMENTS INC., Chiba (JP)

(21) Appl. No.: 14/132,015

(22) Filed: Dec. 18, 2013

(30) Foreign Application Priority Data
Dec. 28, 2012 (JP) 2012-288724

(51) Int. Cl. H01F 38/14

(52) U.S. Cl. CPC H01F 38/14
USPC 307/104

(57) ABSTRACT

To perform wireless power transfer without needing a feedback coil, an electronic component includes: a drive transistor to be connected in series to a resonant circuit, the resonant circuit including a feeding coil for feeding power to a receiving coil and a resonant capacitor configured to resonate with the feeding coil; and a drive control section for controlling the drive transistor. The drive control section includes an ON-signal generation section for generating, when a potential difference across the drive transistor falls within a given threshold range, a control signal for controlling the drive transistor to a conductive state for a predetermined first period and thereafter controlling the drive transistor to a non-conductive state.

### BACKGROUND OF THE INVENTION

1. Field of the Invention

The present invention relates to an electronic component, a power feeding device, and a power feeding system.

2. Description of the Related Art

In recent years, there has been known a power feeding system for supplying electric power by wireless via electromagnetic induction or electromagnetic coupling between a feeding coil and a receiving coil, for example, in order to charge a battery included in a device such as a mobile phone terminal or a personal digital assistant (PDA). In such a power feeding system, a power feeding device on the feed side includes a feeding coil, an oscillation circuit, and a feedback coil (see, for example, Japanese Patent Application Laid-open No. 2012-152049). In the power feeding system described in Japanese Patent Application Laid-open No. 2012-152049, an antiphase voltage is excited in the feedback coil in accordance with a drive voltage of the feeding coil, and the oscillation circuit is constructed by an amplifier stage of a transistor driven by the feedback coil.

In the power feeding system described in Japanese Patent Application Laid-open No. 2012-152049, however, the power feeding device needs two coils for oscillation, i.e. the feeding coil and the feedback coil. Accordingly, the power feeding system described in Japanese Patent Application Laid-open No. 2012-152049 needs to adjust, for example, the degree of coupling between the feeding coil and the feedback coil so that stable oscillation may be obtained. This is responsible for the increased cost. It is therefore desired for the power feeding device to oscillate only with the feeding coil by eliminating the feedback coil.

### SUMMARY OF THE INVENTION

In order to solve the above-mentioned problem, according to one embodiment of the present invention, there is provided an electronic component, including: a switching element to be connected in series to a resonant circuit, the resonant circuit including a feeding coil for feeding power to a receiving coil and a resonant capacitor configured to resonate with the feeding coil; and a drive control section for controlling the switching element, the drive control section including a first signal generation section for generating, when a potential difference across the switching element falls within a given threshold range, a control signal for controlling the switching element to a conductive state for a predetermined first period and thereafter controlling the switching element to a non-conductive state.

Further, in the electronic component according to one embodiment of the present invention, the drive control section further includes a second signal generation section for generating, when the potential difference across the switching element falls outside the given threshold range, a control signal for controlling the switching element to the conductive state after a predetermined second period elapses.

Further, in the electronic component according to one embodiment of the present invention, the second period is determined to be longer than a third period during which the potential difference across the switching element changes to be outside the given threshold range and returns within the given threshold range again by the resonant circuit.

Further, in the electronic component according to one embodiment of the present invention, the second period is determined in consideration of a fluctuation amount of the third period corresponding to a fluctuation in a load connected to the receiving coil.

Further, in the electronic component according to one embodiment of the present invention, the second period is determined in consideration of a fluctuation amount of the third period corresponding to a fluctuation in inductance due to coupling between the feeding coil and the receiving coil.

Further, in the electronic component according to one embodiment of the present invention, the first period and the second period are determined based on a resonant frequency of the resonant circuit.

Further, in the electronic component according to one embodiment of the present invention: the first signal generation section and the second signal generation section each include a resistor and a capacitor; and the first signal generation section generates the first period based on a time constant of the resistor and the capacitor included therein, and the second signal generation section generates the second period based on a time constant of the resistor and the capacitor included therein.

Further, in the electronic component according to one embodiment of the present invention, the drive control section further includes: a determination section for determining whether or not a fourth period during which the switching element becomes the non-conductive state is equal to or less than a predetermined given threshold period; and a third signal generation section for generating, when the determination section determines that the fourth period is equal to or less than the given threshold period, a control signal for controlling the switching element to the non-conductive state for a predetermined fifth period.

Further, according to one embodiment of the present invention, there is provided a power feeding device including: the electronic component; and a resonant circuit including a feeding coil and a resonant capacitor.

Further, according to one embodiment of the present invention, there is provided a power feeding system including: the power feeding device; and a power receiving device including a receiving coil arranged to be opposed to a feeding coil.

According to the present invention, it is possible to perform wireless power transfer without needing the feedback coil.

### BRIEF DESCRIPTION OF THE DRAWINGS

In the accompanying drawings:

FIG. 1 is a schematic block diagram illustrating an exemplary power feeding system according to a first embodiment of the present invention;

FIG. 2 is a timing chart illustrating an exemplary operation of a power feeding device according to the first embodiment;

FIG. 3 is a schematic block diagram illustrating an exemplary power feeding system according to a second embodiment of the present invention;

FIG. 4 is a timing chart illustrating an exemplary operation of a power feeding device according to the second embodiment;

FIG. 5 is a timing chart illustrating another exemplary operation of the power feeding device according to the second embodiment.

FIG. 6 is a schematic block diagram illustrating an exemplary power feeding system according to a third embodiment of the present invention;

FIG. 7 is a timing chart illustrating an exemplary operation of a power feeding device according to the third embodiment;

FIG. 8 is a schematic block diagram illustrating an exemplary power feeding system according to a fourth embodiment of the present invention;

FIG. 9 is a timing chart illustrating an exemplary operation of the power feeding device according to the fourth embodiment; and

FIG. 10 is a timing chart illustrating another exemplary operation of the power feeding device according to the fourth embodiment.

### DETAILED DESCRIPTION OF THE PREFERRED EMBODIMENTS

Now, a power feeding system according to one embodiment of the present invention is described below with reference to the accompanying drawings.

### First Embodiment

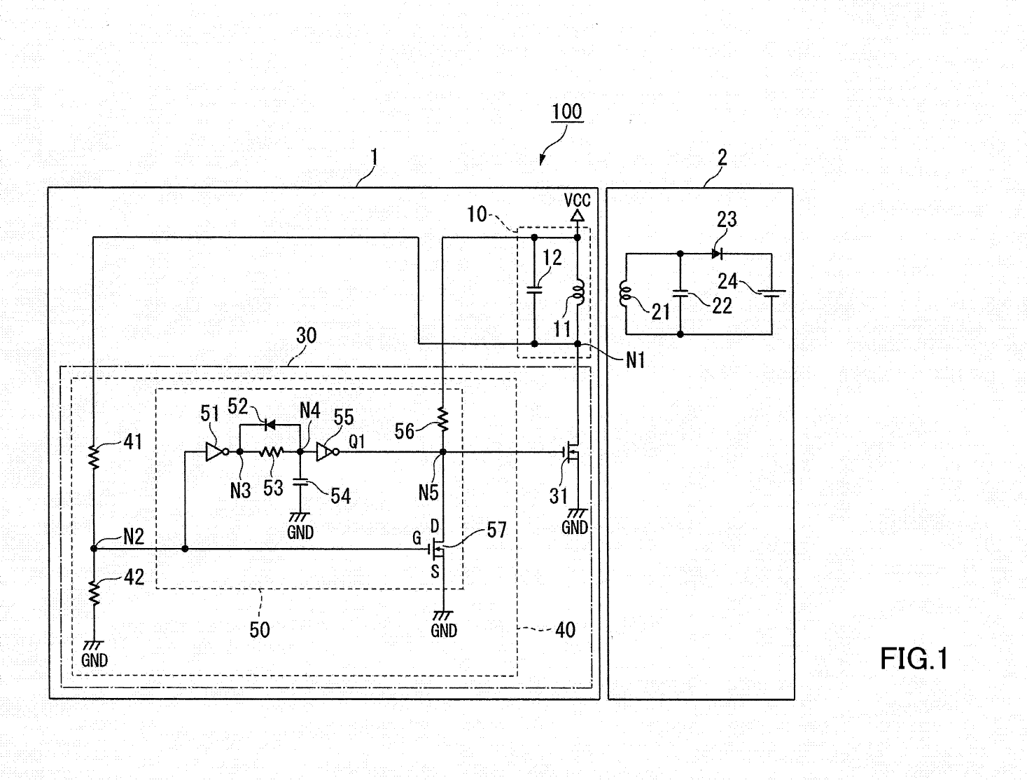

FIG. 1 is a schematic block diagram illustrating an exemplary power feeding system 100 according to a first embodiment of the present invention.

Referring to FIG. 1, the power feeding system 100 includes a power feeding device 1 and a power receiving device 2.

The power feeding system 100 is a system for supplying electric power from the power feeding device 1 to the power receiving device 2 by wireless (in a contactless manner). For example, the power feeding system 100 supplies electric power for charging a battery 24 included in the power receiving device 2 from the power feeding device 1 to the power receiving device 2. The power receiving device 2 is, for example, electronic equipment such as a mobile phone terminal or a PDA. The power feeding device 1 is, for example, a charger compatible with the power receiving device 2.

The power feeding device 1 includes a feeding coil 11, a resonant capacitor 12, and an electronic component 30.

The feeding coil 11 has a first terminal connected to a power supply VCC and a second terminal connected to a node N1. The feeding coil 11 supplies electric power to a receiving coil 21 included in the power receiving device 2 by, for example, electromagnetic induction or electromagnetic coupling. For charging the battery 24, the feeding coil 11 is arranged to be opposed to the receiving coil 21 to feed power to the receiving coil 21 by electromagnetic induction.

The resonant capacitor 12 is connected in parallel to the feeding coil 11, and resonates with the feeding coil 11. The feeding coil 11 and the resonant capacitor 12 construct a resonant circuit 10. The resonant circuit 10 resonates at a given resonant frequency (for example, 100 kHz (kilohertz)) determined by an inductance value of the feeding coil 11 and a capacitance value of the resonant capacitor 12.

The electronic component 30 is, for example, a component such as an integrated circuit (IC). The electronic component 30 may be a module including a plurality of components such as ICs. The electronic component 30 includes a drive transistor 31 and a drive control section 40.

The drive transistor 31 (switching element) is, for example, a field effect transistor (FET transistor), and is connected in series to the resonant circuit 10. In this embodiment, the case where the drive transistor 31 is an N-channel metal oxide semiconductor (MOS) FET is described below as an example. In the following, “MOSFET” sometimes refers to a MOS transistor, and “N-channel MOS transistor” sometimes refers to an NMOS transistor.

Specifically, the drive transistor 31 has a source terminal connected to a power supply GND, a gate terminal connected to an output signal line (node N5) of the drive control section 40, and a drain terminal connected to the node N1. The drive transistor 31 periodically repeats an ON state (conductive state) and an OFF state (non-conductive state) under the control of the drive control section 40. In other words, the supply and release of electric power to and from the resonant circuit 10 are repeated by the switching operation of the drive transistor 31. In this manner, a periodic signal is generated in the feeding coil 11, and power is fed from the feeding coil 11 to the receiving coil 21 by electromagnetic induction.

The drive control section 40 periodically controls the ON state and the OFF state of the drive transistor 31, for example. The drive control section 40 includes a resistor 41, a resistor 42, and an ON-signal generation section 50.

The resistor 41 and the resistor 42 are connected in series between the node N1 serving as a second terminal of the feeding coil 11 and the power supply GND. In other words, the resistor 41 is connected between the node N1 and a node N2, and the resistor 42 is connected between the node N2 and the power supply GND. The resistor 41 and the resistor 42 function as a resistive voltage divider for decreasing the voltage at the node N1 to a withstand voltage range of a circuit element to be connected downstream. Resistance values of the resistor 41 and the resistor 42 are determined in accordance with the withstand voltage of the circuit element to be connected downstream.

The ON-signal generation section 50 (first signal generation section) includes an inverter 51, a diode 52, a resistor 53, a capacitor 54, an open collector output inverter 55, a resistor 56, and a control transistor 57.

The inverter 51 is, for example, an inverter output circuit for outputting a signal obtained by logically inverting an input signal, and has an input terminal connected to the node N2 and an output terminal connected to a node N3.

The diode 52 is connected in parallel to the resistor 53 between the inverter 51 and the open collector output inverter 55, and has an anode terminal connected to a node N4 and a cathode terminal connected to the node N3. When the input logic state of the inverter 51 becomes an H state (high state) and its output becomes an L state (low state), the diode 52 discharges electric charges stored at the node N4 (electric charges charged in the capacitor 54) and thereby immediately sets the node N4 to the L state.

The resistor 53 is connected in parallel to the diode 52 between the node N3 and the node N4. The capacitor 54 is connected between the node N4 and the power supply GND. The resistor 53 and the capacitor 54 construct an RC circuit to determine a turn-on period (ton period) to be described later based on a time constant of the resistor 53 and the capacitor 54.

The open collector output inverter 55 is an inverter output circuit having an open collector output to invert an input signal, and has an input terminal connected to the node N4 and an output terminal connected to the node N5. For example, when the input terminal (node N4) is in the H state, the open collector output inverter 55 outputs the L state to the output terminal (node N5) as an output signal (signal Q1). For example, when the input terminal (node N4) is in the L state, the open collector output inverter 55 outputs an open state (high impedance state) to the output terminal (node N5) as an output signal (signal Q1).

The resistor 56 is connected between the power supply VCC and the node N5. The resistor 56 functions as a pull-up resistor for keeping the node N5 in the H state when the output terminal of the open collector output inverter 55 and a drain terminal of the control transistor 57, which are connected to the node N5, are in the open state.

The control transistor 57 is, for example, an NMOS transistor. The control transistor 57 has a source terminal (S) connected to the power supply GND and the drain terminal (D) connected to the node N5. The control transistor 57 has a gate terminal (G) connected to the node N2.

The control transistor 57 becomes the ON state and outputs the L state to the drain terminal, for example, when the voltage at the node N2 obtained by dividing the voltage at the terminal of the feeding coil 11 (node N1) by the resistor 41 and the resistor 42 is equal to or more than a threshold voltage of the control transistor 57. The control transistor 57 becomes the OFF state and outputs the open state to the drain terminal when the voltage at the node N2 is less than the threshold voltage of the control transistor 57.

In the ON-signal generation section 50, when the fall of the voltage at the terminal of the feeding coil 11 (node N1) is detected, the control transistor 57 becomes the OFF state, and the open collector output inverter 55 outputs the open state for a ton period (first period). Then, when the capacitor 54 is charged by the RC circuit and the node N4 becomes the H state (corresponding to timing after the lapse of the ton period), the open collector output inverter 55 outputs the L state. In this manner, the ON-signal generation section 50 outputs the H state to the gate terminal of the drive transistor 31 for the ton period (first period) since the fall of the voltage at the terminal of the feeding coil 11 (node N1).

As described above, when a potential difference across the drive transistor 31 (voltage at the node N1) falls within a given threshold range (for example, the range less than the threshold voltage of the control transistor 57), the ON-signal generation section 50 generates a control signal for controlling the drive transistor 31 to the ON state for the predetermined ton period and thereafter controlling the drive transistor 31 to the OFF state.

The power receiving device 2 includes a receiving coil 21, a resonant capacitor 22, a diode 23, and a battery 24.

The receiving coil 21 is supplied with electric power from a feeding coil 11 included in the power feeding device 1 by, for example, electromagnetic induction or electromagnetic coupling. For charging the battery 24, the receiving coil 21 is arranged to be opposed to the feeding coil 11 to be fed with power from the feeding coil 11 by electromagnetic induction.

The resonant capacitor 22 is connected in parallel to the receiving coil 21, and resonates with the receiving coil 21. The receiving coil 21 and the resonant capacitor 22 construct a resonant circuit and resonate at a given resonant frequency (for example, 100 kHz) determined by an inductance value of the receiving coil 21 and a capacitance value of the resonant capacitor 22. In this embodiment, the resonant frequency of the power receiving device 2 and the resonant frequency of the power feeding device 1 are equal to each other, for example, 100 kHz.

The diode 23 is, for example, a rectifier diode. The diode 23 converts AC power (AC voltage) generated across the receiving coil 21 into DC power (DC voltage), thereby supplying the battery 24 with electric power for charging.

The battery 24 is, for example, a storage battery or a secondary battery. The battery 24 is charged by the DC voltage rectified by the diode 23.

Next, the operation of the power feeding system 100 according to this embodiment is described below.

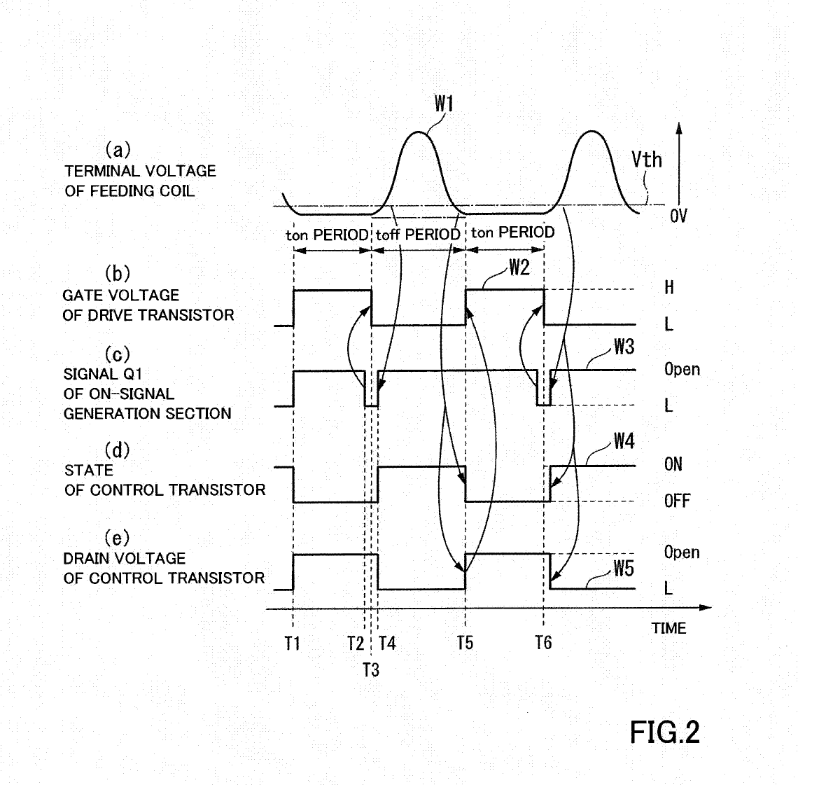

First, the operation of the power feeding device 1 included in the power feeding system 100 is described with reference to FIG. 2.

FIG. 2 is a timing chart illustrating an exemplary operation of the power feeding device 1 according to this embodiment.

In FIG. 2, waveforms W1 to W5 represent, in order from the top, the waveforms of (a) the terminal voltage of the feeding coil (voltage at the node N1), (b) the gate voltage of the drive transistor 31, (c) the signal Q1 of the ON-signal generation section 50, (d) the state of the control transistor 57, and (e) the drain voltage of the control transistor 57. The vertical axes of the respective waveforms represent the voltage in (a), the conductive (ON)/non-conductive (OFF) state in (d), and the logic state in (b), (c), and (e). The horizontal axis represents time. A voltage Vth is a threshold voltage for operating the ON-signal generation section 50.

In FIG. 2, the period from a time T1 to a time T3 and the period from a time T5 to a time T6 each correspond to the ton period. The period from the time T3 to the time T5 corresponds to a turn-off period (toff period). The ton period and the toff period are determined, for example, so that a total period of the ton period and the toff period may fall within a period of 10 μs (microseconds) at the resonant frequency of 100 kHz. In other words, the ton period and the toff period are determined based on the resonant frequency of the resonant circuit 10.

First, at the time T1, when the terminal voltage of the feeding coil 11 decreases to be less than the threshold voltage Vth, the ON-signal generation section 50 outputs the open state to the signal Q1. In other words, when the terminal voltage of the feeding coil 11 decreases to be less than the threshold voltage Vth, the inverter 51 outputs the H state to start charging the capacitor 54 via the resistor 53. In response thereto, the voltage at the node N4 starts increasing, but the node N4 is still in the L state at the time T1. Accordingly, the open collector output inverter 55 outputs the open state to the output signal Q1 (see waveform W3). As used herein, the terminal voltage of the feeding coil 11 refers to the voltage at the node N1.

When the terminal voltage of the feeding coil 11 decreases to be less than the threshold voltage Vth, on the other hand, the control transistor 57 becomes the OFF state as indicated by the waveform W4, with the result that the drain voltage (voltage at the drain terminal (D)) of the control transistor 57 becomes the open state as indicated by the waveform W5. In response thereto, the node N5 is supplied with the power supply VCC via the resistor 56, and the gate voltage of the drive transistor 31 becomes the H state as indicated by the waveform W2, and hence the drive transistor 31 becomes the ON state.

Next, when the capacitor 54 is further charged and the node N4 becomes the H state at the time T2, the open collector output inverter 55 outputs the L state to the output signal Q1 (see waveform W3).

As a result, at the time T3, the node N5 transitions from the H state to the L state, and the drive transistor 31 becomes the OFF state. In response thereto, electric power stored in the feeding coil 11 of the resonant circuit 10 is released, and the resonant circuit 10 increases the terminal voltage of the feeding coil 11.

As described above, when the terminal voltage of the feeding coil 11 decreases to be less than the threshold voltage Vth, the ON-signal generation section 50 outputs the H state as the gate voltage of the drive transistor 31 for the ton period (first period). In response thereto, the drive transistor 31 becomes the ON state, and the terminal voltage of the feeding coil 11 is maintained to 0 V for the ton period. Then, after the lapse of the ton period, the ON-signal generation section 50 outputs the L state as the gate voltage of the drive transistor 31 and hence the drive transistor 31 becomes the OFF state. As a result, a periodically curved high voltage is generated in the second terminal of the feeding coil 11 (node N1) by the resonant circuit 10 of the feeding coil 11 and the resonant capacitor 12.

Next, at the time T4, when the terminal voltage of the feeding coil 11 becomes equal to or more than the threshold voltage Vth, the ON-signal generation section 50 outputs the open state to the signal Q1 again. In other words, when the terminal voltage of the feeding coil 11 increases to be equal to or more than the threshold voltage Vth, the inverter 51 outputs the L state to discharge the electric charges charged in the capacitor 54 via the diode 52. In response thereto, the voltage at the node N4 becomes the L state again and hence the open collector output inverter 55 outputs the open state to the output signal Q1 (see waveform W3).

When the terminal voltage of the feeding coil 11 increases to be equal to or more than the threshold voltage Vth, the control transistor 57 becomes the ON state as indicated by the waveform W4, with the result that the control transistor 57 outputs the L state as the drain voltage as indicated by the waveform W5. Then, the gate voltage of the drive transistor 31 becomes the L state, and hence the OFF state of the drive transistor 31 is maintained.

Next, at the time T5, when the terminal voltage of the feeding coil 11 decreases to be less than the threshold voltage Vth, similarly to the case at the above-mentioned time T1, the ON-signal generation section 50 outputs the open state to the signal Q1, and the control transistor 57 becomes the OFF state. As a result, the gate voltage of the drive transistor 31 becomes the H state, and hence the drive transistor 31 becomes the ON state again.

The toff period from the time T3 to the time T5 is a period during which the terminal voltage of the feeding coil 11 changes to be outside a given threshold range (range of from 0 V to the threshold voltage Vth) and returns within the given threshold range again by the resonant circuit 10.

The operation of the power feeding device 1 at the next time T6 is the same as the operation of the power feeding device 1 at the above-mentioned time T3.

In other words, the drive control section 40 switches the drive transistor 31 in synchronization with the fall of the terminal voltage of the feeding coil 11, and the oscillation as represented by the waveform W1 is thereby continued.

In this manner, the power feeding device 1 generates the voltage waveform as represented by the waveform W1 in the feeding coil 11, to thereby supply AC power to the receiving coil 21 of the power receiving device 2 in a contactless manner.

In the power receiving device 2, the diode 23 rectifies (converts) the AC power supplied from the feeding coil 11 of the power feeding device 1 to the receiving coil 21 into DC power to be supplied to the battery 24. As a result, the battery 24 is charged.

As described above, the electronic component 30 according to this embodiment includes the drive transistor 31 connected in series to the resonant circuit 10, and the drive control section 40 for controlling the drive transistor 31. The resonant circuit 10 includes the feeding coil 11 for feeding power to the receiving coil 21, and the resonant capacitor 12 that resonates with the feeding coil 11. Then, the drive control section 40 includes the ON-signal generation section 50. When the potential difference across the drive transistor 31 (for example, the voltage at the node N1) falls within a given threshold range (for example, within the range of from 0 V to the threshold voltage Vth), the ON-signal generation section 50 generates a control signal for controlling the drive transistor 31 to the ON state (conductive state) for the predetermined ton period (first period) and thereafter controlling the drive transistor 31 to the OFF state (non-conductive state).

With this configuration, the electronic component 30 according to this embodiment allows the feeding coil 11 of the power feeding device 1 to oscillate as represented by the waveform W1. Consequently, the electronic component 30 according to this embodiment can perform wireless power transfer without needing a feedback coil. Because the oscillation can be performed only by the feeding coil 11 by eliminating the feedback coil, the electronic component 30 according to this embodiment can simplify the configuration of the power feeding device 1, thus saving the space (downsizing) and reducing the weight. Besides, the electronic component 30 according to this embodiment is not required to adjust the degree of coupling between the feeding coil 11 and the feedback coil so that stable oscillation may be obtained. Consequently, the electronic component 30 according to this embodiment can reduce the cost for manufacturing the power feeding device 1.

The ON-signal generation section 50 switches the drive transistor 31 when the terminal voltage of the feeding coil 11 (voltage at the node N1) is around 0 V. In other words, the ON-signal generation section 50 switches the drive transistor 31 when the potential difference across the drive transistor 31 (between the source terminal and the drain terminal) is around 0 V. With this configuration, the change in potential across the drive transistor 31 (between the source terminal and the drain terminal) in switching can be suppressed, and hence the electronic component 30 according to this embodiment can reduce heat generation of the feeding coil 11 and the drive transistor 31.

The power feeding device 1 according to this embodiment includes the electronic component 30 and the resonant circuit 10 including the feeding coil 11 and the resonant capacitor 12. The power feeding system 100 according to this embodiment includes the power feeding device 1 and the power receiving device 2 including the receiving coil 21 to be arranged to be opposed to the feeding coil 11.

With this configuration, the power feeding device 1 and the power feeding system 100 according to this embodiment can perform wireless power transfer without needing a feedback coil similarly to the above-mentioned electronic component 30. Then, the power feeding device 1 and the power feeding system 100 according to this embodiment can reduce the cost for manufacturing the power feeding device 1.

Next, a second embodiment according to the present invention is described below with reference to the accompanying drawings.

### Second Embodiment

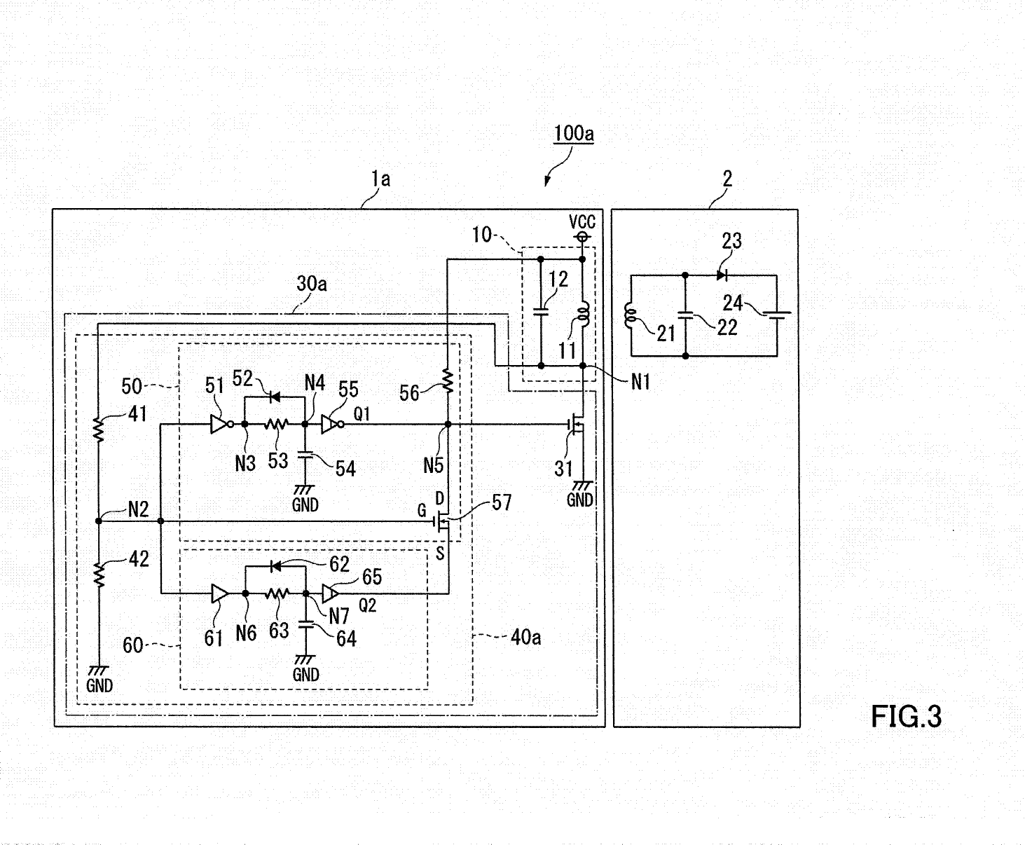

FIG. 3 is a schematic block diagram illustrating an exemplary power feeding system 100a according to the second embodiment of the present invention. In FIG. 3, the same configurations as in FIG. 1 are denoted by the same reference symbols, and descriptions thereof are omitted.

Referring to FIG. 3, the power feeding system 100a includes a power feeding device 1a and a power receiving device 2.

The power feeding system 100a is a system for supplying electric power from the power feeding device 1a to the power receiving device 2 by wireless (in a contactless manner). For example, the power feeding system 100a supplies electric power for charging a battery 24 included in the power receiving device 2 from the power feeding device 1a to the power receiving device 2.

The power feeding device 1a includes a feeding coil 11, a resonant capacitor 12, and an electronic component 30a. The electronic component 30a includes a drive transistor 31 and a drive control section 40a. The drive control section 40a includes a resistor 41, a resistor 42, an ON-signal generation section 50, and an OFF-signal generation section 60.

This embodiment is different from the first embodiment in that the OFF-signal generation section 60 is provided. The configuration of the OFF-signal generation section 60 is described below.

When a potential difference across the drive transistor 31 (voltage at the node N1) falls outside a given threshold range (for example, a range of from 0 V to a threshold voltage Vth), the OFF-signal generation section 60 (second signal generation section) generates a control signal for controlling the drive transistor 31 to the ON state after a predetermined toffMAX period (second period) elapses.

The toffMAX period represents an upper limit value of the above-mentioned toff period, and is determined to be, for example, longer than a toff period (third period) during which the terminal voltage of the drive transistor 31 (voltage at the node N1) increases from 0 V and returns to 0 V again by the resonant circuit 10. In other words, the toffMAX period is determined to be longer than a period during which the potential difference across the drive transistor 31 changes to be outside a given threshold range (for example, the range of from 0 V to the threshold voltage Vth) and returns within the given threshold range by the resonant circuit 10.

The toff period fluctuates in accordance with a fluctuation in load of the power receiving device 2 (fluctuation in load connected to the receiving coil 21) or a fluctuation in inductance due to the coupling between the feeding coil 11 and the receiving coil 21. The toffMAX period is determined to be longer than the toff period in consideration of a fluctuation amount of the toff period corresponding to the fluctuation in load of the power receiving device 2 or the fluctuation in inductance due to the coupling between the feeding coil 11 and the receiving coil 21.

For example, the toffMAX period is calculated by Expression (1).

toffMAX period=standard toff period+ΔTL+ΔTk+α (1)

In Expression (1), the standard toff period is calculated based on the resonant frequency of the resonant circuit 10. The fluctuation amount ΔTL represents a fluctuation amount in load of the power receiving device 2, and the fluctuation amount ΔTk represents a fluctuation amount in inductance. The variable a represents a given margin.

The OFF-signal generation section 60 includes a buffer 61, a diode 62, a resistor 63, a capacitor 64, and an open collector output buffer 65.

The buffer 61 is, for example, an output circuit for outputting a logic signal equal to an input signal, and has an input terminal connected to the node N2 and an output terminal connected to a node N6.

The diode 62 is connected in parallel to the resistor 63 between the buffer 61 and the open collector output buffer 65, and has an anode terminal connected to a node N7 and a cathode terminal connected to the node N6. When the output of the buffer 61 becomes an L state, the diode 62 discharges electric charges stored at the node N7 (electric charges charged in the capacitor 64) and thereby immediately sets the node N7 to the L state.

The resistor 63 is connected in parallel to the diode 62 between the node N6 and the node N7. The capacitor 64 is connected between the node N7 and the power supply GND. The resistor 63 and the capacitor 64 construct an RC circuit to determine a toffMAX period based on a time constant of the resistor 63 and the capacitor 64.

The open collector output buffer 65 is an output circuit having an open collector output to invert an input signal, and has an input terminal connected to the node N7 and an output terminal connected to the source terminal (S) of the control transistor 57. For example, when the input terminal (node N7) is in the H state, the open collector output buffer 65 outputs an open state (high impedance state) to the output terminal as an output signal (signal Q2). For example, when the input terminal (node N7) is in the L state, the open collector output buffer 65 outputs the L state to the output terminal as an output signal (signal Q2).

Next, the operation of the power feeding system 100a according to this embodiment is described below.

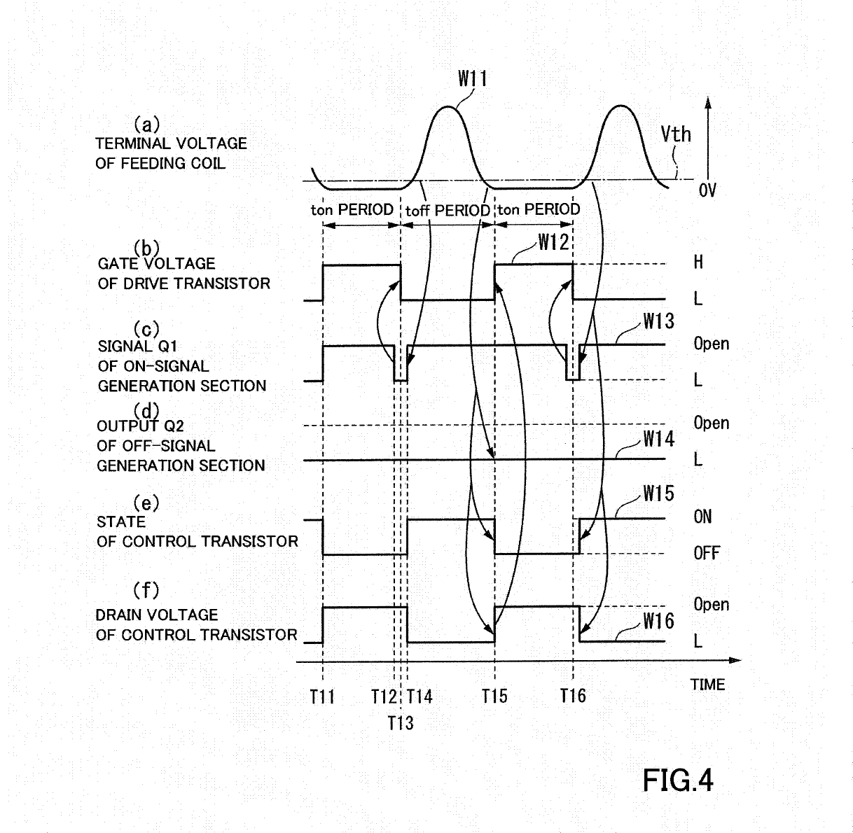

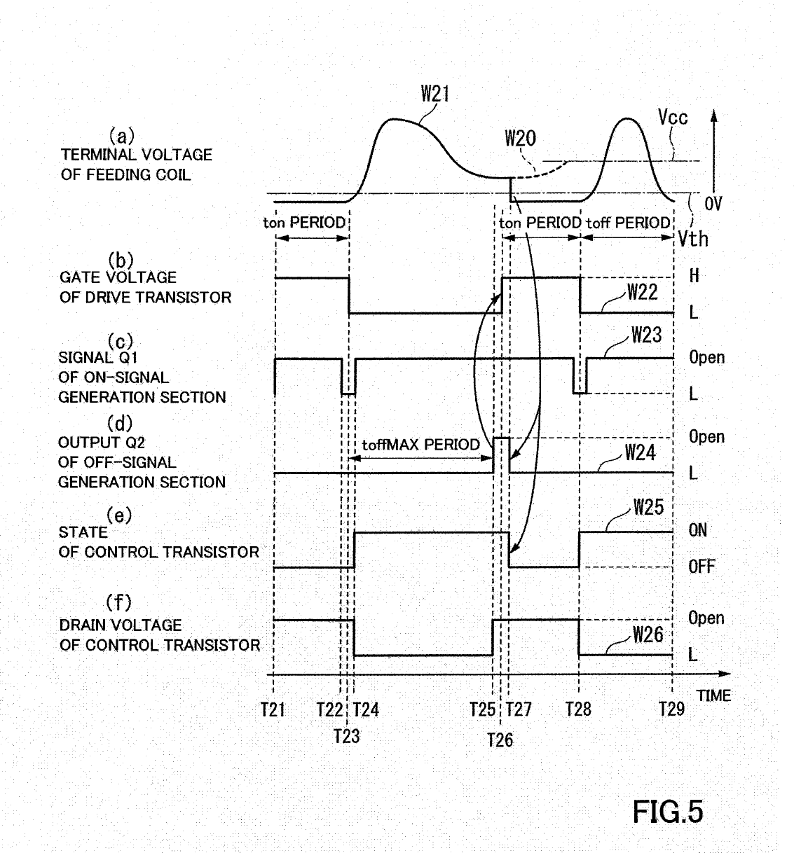

First, the operation of the power feeding device 1a included in the power feeding system 100a is described with reference to FIG. 4 and FIG. 5.

FIG. 4 is a timing chart illustrating an exemplary operation of the power feeding device 1a according to this embodiment. The timing chart of FIG. 4 illustrates an exemplary operation of the power feeding device 1a in the case where no abrupt load fluctuation occurs in the power receiving device 2.

In FIG. 4, waveforms W11 to W16 represent, in order from the top, the waveforms of (a) the terminal voltage of the feeding coil (voltage at the node N1), (b) the gate voltage of the drive transistor 31, (c) the signal Q1 of the ON-signal generation section 50, (d) the output Q2 of the OFF-signal generation section 60, (e) the state of the control transistor 57, and (f) the drain voltage of the control transistor 57. The vertical axes of the respective waveforms represent the voltage in (a), the conductive (ON)/non-conductive (OFF) state in (e), and the logic state in (b) to (d) and (f). The horizontal axis represents time. A voltage Vth is a threshold voltage for operating the ON-signal generation section 50 and the OFF-signal generation section 60.

In FIG. 4, the period from a time T11 to a time T13 and the period from a time T15 to a time T16 each correspond to the ton period. The period from the time T13 to the time T15 corresponds to a toff period.

In FIG. 4, the time T11 to the time T16 correspond to the time T1 to the time T6 of FIG. 2. The waveforms W11 to W13, the waveform W15, and the waveform W16 correspond to the waveforms W1 to W5 of FIG. 2. The operations of those waveforms are the same as those in the first embodiment, and hence the descriptions thereof are omitted. In this embodiment, the operation performed by the OFF-signal generation section 60 is added, but this operation assumes that no abrupt load fluctuation occurs in the power receiving device 2, and hence the toff period transitions to the ton period before reaching the toffMAX period. Accordingly, the OFF-signal generation section 60 maintains the output Q2 to the L state and does not output the H state. Thus, when no abrupt load fluctuation occurs in the power receiving device 2, the power feeding device 1a performs the same operation as that in the first embodiment.

In the case illustrated in FIG. 4, in response to the rise of the terminal voltage of the feeding coil 11 (waveform W11) at the time T14, the buffer 61 of the OFF-signal generation section 60 outputs the H state to start charging the capacitor 64 via the resistor 63. In response thereto, the voltage at the node N7 gradually increases. Next, in response to the fall of the terminal voltage of the feeding coil 11 at the time T15, the buffer 61 outputs the L state again to discharge the capacitor 64 via the diode 62, thereby resetting the node N7 to the state of 0 V. In this manner, because the terminal voltage of the feeding coil 11 does not maintain the state equal to or more than the threshold voltage Vth for the toffMAX period or more in this case, the OFF-signal generation section 60 maintains the output Q2 to the L state.

The control transistor 57, on the other hand, maintains the ON state for the period during which the terminal voltage of the feeding coil 11 exceeds the threshold voltage Vth. Accordingly, the gate voltage of the drive transistor 31 is maintained to the L state for the toff period (for example, the period from the time T13 to the time T15).

FIG. 5 is a timing chart illustrating another exemplary operation of the power feeding device 1a according to this embodiment. The timing chart of FIG. 5 illustrates an exemplary operation of the power feeding device 1a in the case where an abrupt load fluctuation occurs in the power receiving device 2.

In FIG. 5, waveforms W21 to W26 represent, in order from the top, the waveforms of (a) the terminal voltage of the feeding coil 11 (voltage at the node N1), (b) the gate voltage of the drive transistor 31, (c) the signal Q1 of the ON-signal generation section 50, (d) the output Q2 of the OFF-signal generation section 60, (e) the state of the control transistor 57, and (f) the drain voltage of the control transistor 57. For comparison, a waveform W20 represents the waveform of the terminal voltage of the feeding coil 11 (voltage at the node N1) obtained when the OFF-signal generation section 60 is not provided.

The vertical axes of the respective waveforms represent the voltage in (a), the conductive (ON)/non-conductive (OFF) state in (e), and the logic state in (b) to (d) and (f). The horizontal axis represents time. A voltage Vth is a threshold voltage for operating the ON-signal generation section 50 and the OFF-signal generation section 60.

In FIG. 5, the period from a time T21 to a time T23 and the period from a time T26 to a time T28 each correspond to the ton period. The period from the time T28 to a time T29 corresponds to a toff period.

As illustrated in FIG. 5, first, at the time T21, when the terminal voltage of the feeding coil 11 decreases to be less than the threshold voltage Vth, the ON-signal generation section 50 outputs the open state to the signal Q1. In other words, when the terminal voltage of the feeding coil 11 decreases to be less than the threshold voltage Vth, the inverter 51 outputs the H state to start charging the capacitor 54 via the resistor 53. In response thereto, the voltage at the node N4 starts increasing, but the node N4 is still in the L state at the time T21. Accordingly, the open collector output inverter 55 outputs the open state to the output signal Q1 (see waveform W23).

When the terminal voltage of the feeding coil 11 decreases to be less than the threshold voltage Vth, on the other hand, the control transistor 57 becomes the OFF state as indicated by the waveform W25, with the result that the drain voltage (voltage at the drain terminal (D)) of the control transistor 57 becomes the open state as indicated by the waveform W26. In response thereto, the node N5 is supplied with the power supply VCC via the resistor 56, and the gate voltage of the drive transistor 31 becomes the H state as indicated by the waveform W22, and hence the drive transistor 31 becomes the ON state.

Next, when the capacitor 54 is further charged and the node N4 becomes the H state at the time T22, the open collector output inverter 55 outputs the L state to the output signal Q1 (see waveform W23).

As a result, at the time T23, the node N5 transitions from the H state to the L state, and the drive transistor 31 becomes the OFF state. In response thereto, electric power stored in the feeding coil 11 of the resonant circuit 10 is released, and the resonant circuit 10 increases the terminal voltage of the feeding coil 11. In other words, a periodically curved high voltage is generated in the second terminal of the feeding coil 11 (node N1) by the resonant circuit 10 of the feeding coil 11 and the resonant capacitor 12.

Next, at the time T24 when the terminal voltage of the feeding coil 11 exceeds the threshold voltage Vth, the control transistor 57 transitions from the OFF state to the ON state. The buffer 61 of the OFF-signal generation section 60 outputs the H state to start charging the capacitor 64 via the resistor 63.

On this occasion, in the normal case where no abrupt load fluctuation occurs in the power receiving device 2, the voltage at the second terminal of the feeding coil 11 (node N1) drops in a curve to around 0 V again, but in the case where an abrupt load fluctuation occurs in the power receiving device 2, the terminal voltage of the feeding coil 11 has the voltage waveform as represented by the waveform W20. This is because magnetic energy consumption of the feeding coil 11 fluctuates when the abrupt load fluctuation occurs in the power receiving device 2. As a result, the terminal voltage of the feeding coil 11 cannot drop to 0 V, but approaches a voltage Vcc of the power supply VCC.

However, the power feeding device 1a according to this embodiment includes the OFF-signal generation section 60, and hence, at the time T25 after the lapse of the toffMAX period, the voltage at the node N7 in the OFF-signal generation section 60 becomes the H state due to the charge of the capacitor 64, with the result that the open collector output buffer 65 outputs the open state to the output Q2. In other words, the OFF-signal generation section 60 outputs the open state to the output Q2. At this time, the signal Q1 of the ON-signal generation section 50 is also in the open state, and hence the node N5 becomes the H state due to the voltage supplied from the power supply VCC via the resistor 56.

In response thereto, the gate voltage of the drive transistor 31 becomes the H state, and hence the drive transistor 31 becomes the ON state at the time T26.

Then, the terminal voltage of the feeding coil 11 decreases to be less than the threshold voltage Vth, and hence the ON-signal generation section 50 restarts the ton period at the time T27. In other words, the ON-signal generation section 50 outputs a control signal for controlling the drive transistor 31 to the ON state during the period from the time T27 to the time T28 to the gate terminal of the drive transistor 31.

As described above, the drive control section 40a according to this embodiment includes the OFF-signal generation section 60 for generating, when the potential difference across the drive transistor 31 falls outside a given threshold range, a control signal for controlling the drive transistor 31 to the ON state after the lapse of the predetermined toffMAX period (second period).

With this configuration, the electronic component 30a according to this embodiment exhibits the same effects as those in the first embodiment, and, for example, can perform stable oscillation even when an abrupt load fluctuation occurs in the power receiving device 2.

In this embodiment, the toffMAX period is determined to be longer than the toff period during which the potential difference across the drive transistor 31 changes to be outside a given threshold range (for example, outside the range of from 0 V to the threshold voltage Vth) and returns within the given threshold range again by the resonant circuit 10.

With this configuration, the electronic component 30a according to this embodiment can prevent the OFF-signal generation section 60 from operating before the terminal voltage of the feeding coil 11 becomes around 0 V in the normal operation in which no abrupt load fluctuation occurs in the power receiving device 2. In the normal operation, the electronic component 30a according to this embodiment can switch the drive transistor 31 when the terminal voltage of the feeding coil 11 is around 0 V. Consequently, the electronic component 30a according to this embodiment can efficiently feed power to the power receiving device 2 and reduce the heat generation of the feeding coil 11 and the drive transistor 31.

In this embodiment, the toffMAX period is determined in consideration of a fluctuation amount of the toff period corresponding to a fluctuation in load connected to the receiving coil 21.

With this configuration, even when the load of the power receiving device 2 fluctuates, the electronic component 30a according to this embodiment can efficiently feed power to the power receiving device 2 and reduce the heat generation of the feeding coil 11 and the drive transistor 31.

In this embodiment, the toffMAX period is determined in consideration of a fluctuation amount of the toff period corresponding to a fluctuation in inductance due to the coupling between the feeding coil 11 and the receiving coil 21.

With this configuration, even when the positional relationship between the feeding coil 11 and the receiving coil 21 fluctuates, the electronic component 30a according to this embodiment can efficiently feed power to the power receiving device 2 and reduce the heat generation of the feeding coil 11 and the drive transistor 31.

In this embodiment, the ton period and the toffMAX period are determined based on the resonant frequency of the resonant circuit 10. By appropriately setting the ton period and the toffMAX period based on the resonant frequency of the resonant circuit 10, the electronic component 30a according to this embodiment can obtain the oscillation frequency closer to the resonant frequency. Consequently, the electronic component 30a according to this embodiment can improve feed efficiency from the power feeding device la to the power receiving device 2 with simple means.

In this embodiment, the ON-signal generation section 50 and the OFF-signal generation section 60 each include the resistor (53, 63) and the capacitor (54, 64). The ON-signal generation section 50 and the OFF-signal generation section 60 generate the ton period and the toffMAX period based on the time constants of the respective resistors (53, 63) and the respective capacitors (54, 64).

Consequently, the electronic component 30a according to this embodiment can perform stable oscillation with a simple configuration.

Similarly to the electronic component 30a, the power feeding device 1a and the power feeding system 100a according to this embodiment can perform stable oscillation even when, for example, an abrupt load fluctuation occurs in the power receiving device 2.

Next, a third embodiment according to the present invention is described below with reference to the accompanying drawings.

### Third Embodiment

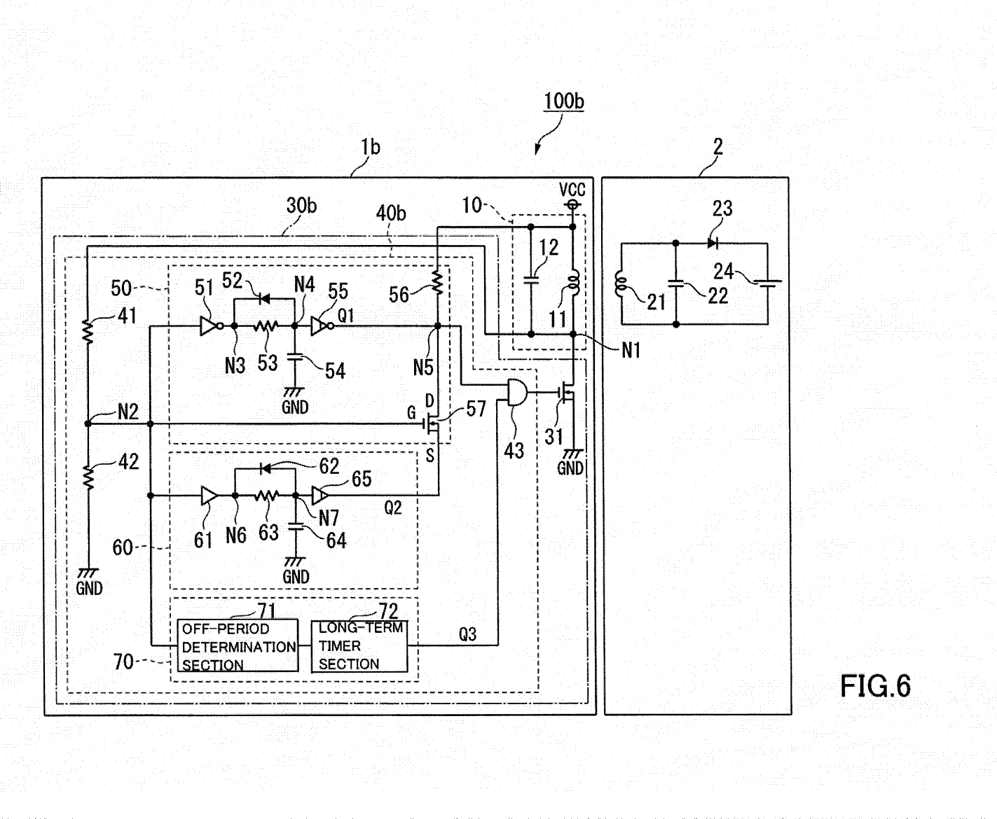

FIG. 6 is a schematic block diagram illustrating an exemplary power feeding system 100b according to the third embodiment of the present invention. In FIG. 6, the same configurations as in FIG. 1 and FIG. 3 are denoted by the same reference symbols, and descriptions thereof are omitted.

Referring to FIG. 6, the power feeding system 100b includes a power feeding device 1b and a power receiving device 2.

The power feeding system 100b is a system for supplying electric power from the power feeding device 1b to the power receiving device 2 by wireless (in a contactless manner). For example, the power feeding system 100b supplies electric power for charging a battery 24 included in the power receiving device 2 from the power feeding device 1b to the power receiving device 2.

The power feeding device 1b includes a feeding coil 11, a resonant capacitor 12, and an electronic component 30b. The electronic component 30b includes a drive transistor 31 and a drive control section 40b. The drive control section 40b includes a resistor 41, a resistor 42, an AND circuit 43, an ON-signal generation section 50, an OFF-signal generation section 60, and a heating prevention section 70.

This embodiment is different from the second embodiment in that the heating prevention section 70 and the AND circuit 43 are provided. The configurations of the heating prevention section 70 and the AND circuit 43 are described below.

When the toff period (corresponding to a fourth period in this case) is equal to or less than a predetermined toffMIN period, the heating prevention section 70 sets the drive transistor 31 to the OFF state for a predetermined oscillation stop period (fifth period). The heating prevention section 70 includes an OFF-period determination section 71 and a long-term timer section 72.

The OFF-period determination section 71 (determination section) determines whether or not the period during which the terminal voltage of the feeding coil 11 increases from 0 V and returns to 0 V again is equal to or less than a predetermined given threshold period (for example, the toffMIN period). In other words, the OFF-period determination section 71 detects the period (fourth period) during which the terminal voltage of the feeding coil 11 increases from 0 V and returns to 0 V again, and determines whether or not the detected period is equal to or less than, for example, the toffMIN period. The period during which the terminal voltage of the feeding coil 11 increases from 0 V and returns to 0 V again corresponds to the toff period during which the drive transistor 31 is set to the OFF state. As a result of the determination, when the toff period is equal to or less than the toffMIN period, the OFF-period determination section 71 outputs, for example, the L state as an output signal. As a result of the determination, when the toff period is longer than the toffMIN period, the OFF-period determination section 71 outputs, for example, the H state as an output signal.

When it is determined by the OFF-period determination section 71 that the toff period is equal to or less than the toffMIN period, the long-term timer section 72 (third signal generation section) generates a control signal for controlling the drive transistor 31 to the OFF state for a predetermined oscillation stop period. The long-term timer section 72 outputs a control signal indicating the L state for the oscillation stop period as an output Q3. The long-term timer section 72 includes, for example, a resistor (not shown) and a capacitor (not shown) similarly to the ON-signal generation section 50 and the OFF-signal generation section 60 described above. The resistor and the capacitor construct an RC circuit to determine the oscillation stop period based on a time constant of the resistor and the capacitor.

The AND circuit 43 is an operational circuit that implements AND logical operation (logical conjunction) of two input signals. The AND circuit 43 has a first input terminal connected to the node N5 and a second input terminal connected to a signal line of the output Q3 of the long-term timer section 72. The AND circuit 43 has an output terminal connected to the gate terminal of the drive transistor 31. In the above-mentioned oscillation stop period, the AND circuit 43 outputs the L state to the gate terminal of the drive transistor 31 because the output Q3 becomes the L state. As a result, the drive transistor 31 becomes the OFF state so as to extend the toff period by the predetermined oscillation stop period.

Next, the operation of the power feeding system 100b according to this embodiment is described below.

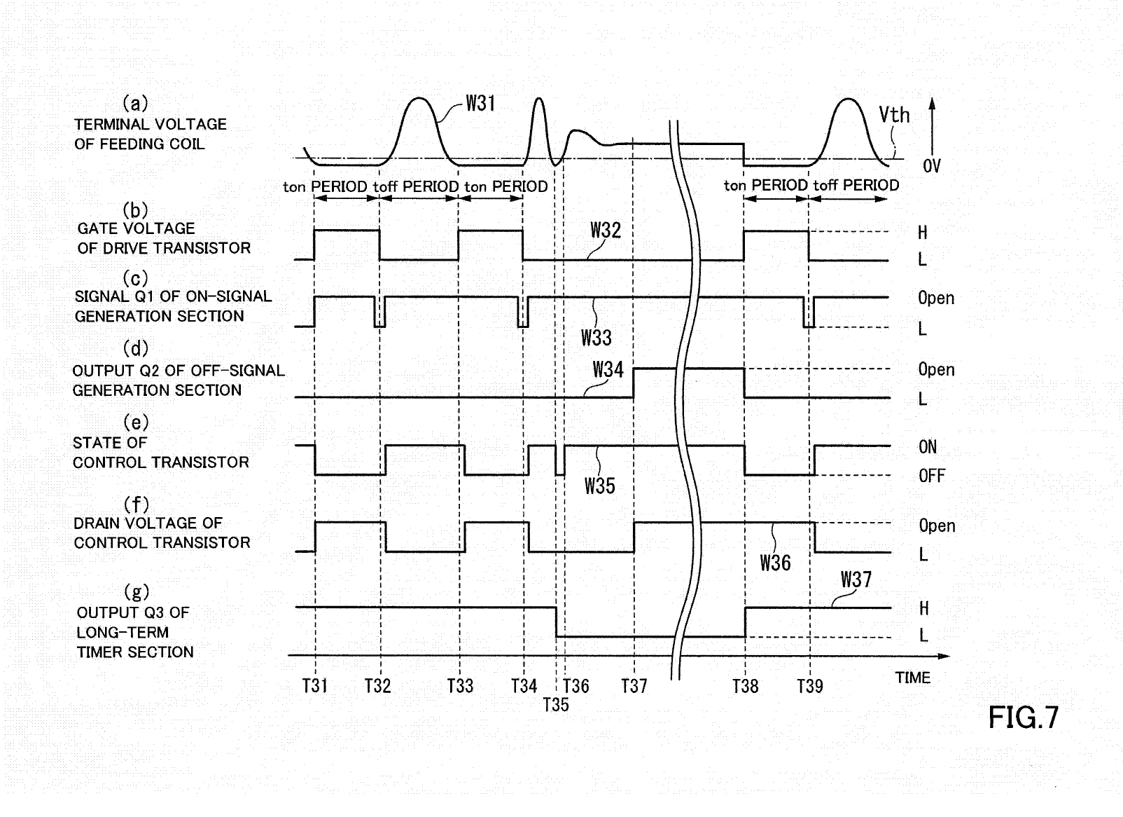

First, the operation of the power feeding device 1b included in the power feeding system 100b is described with reference to FIG. 7.

FIG. 7 is a timing chart illustrating an exemplary operation of the power feeding device 1b according to this embodiment. The operation of the power feeding device 1b in the case where an abrupt load fluctuation occurs in the power receiving device 2 is the same as that in the second embodiment illustrated in FIG. 5, and hence the description thereof is herein omitted.

In FIG. 7, waveforms W31 to W37 represent, in order from the top, the waveforms of (a) the terminal voltage of the feeding coil (voltage at the node N1), (b) the gate voltage of the drive transistor 31, (c) the signal Q1 of the ON-signal generation section 50, (d) the output Q2 of the OFF-signal generation section 60, (e) the state of the control transistor 57, (f) the drain voltage of the control transistor 57, and (g) the output Q3 of the long-term timer section 72. The vertical axes of the respective waveforms represent the voltage in (a), the conductive (ON)/non-conductive (OFF) state in (e), and the logic state in (b) to (d), (f), and (g). The horizontal axis represents time. A voltage Vth is a threshold voltage for operating the ON-signal generation section 50 and the OFF-signal generation section 60.

In FIG. 7, the period from a time T31 to a time T32, the period from a time T33 to a time T34, and the period from a time T38 to a time T39 each correspond to the ton period. The period from the time T32 to the time T33 and the period after the time T39 each correspond to a toff period.

First, the ON-signal generation section 50 sets the gate voltage of the drive transistor 31 to the H state at the time T31, and sets the gate voltage of the drive transistor 31 to the L state at the time T32. In other words, the ON-signal generation section 50 sets the gate voltage of the drive transistor 31 to the H state in the period from the time T31 to the time T32 (ton period) as indicated by the waveform W32, and thereafter sets the gate voltage of the drive transistor 31 to the L state. Accordingly, the drive transistor 31 becomes the ON state in the period from the time T31 to the time T32, and thereafter becomes the OFF state.

Next, at the time T33, as indicated by the waveform W33, the ON-signal generation section 50 operates again in response to the fall of the terminal voltage of the feeding coil 11, to set the gate voltage of the drive transistor 31 to the H state so that the drive transistor 31 becomes the ON state. Then, similarly to the period from the time T31 to the time T32, the ON-signal generation section 50 sets the drive transistor 31 to the ON state in the period from the time T33 to the time T34, and thereafter sets the drive transistor 31 to the OFF state.

On this occasion, for example, if a user of the power feeding system 100b places a metallic foreign object such as a coin on the feeding coil 11 by mistake, an Eddy current may be generated in the metallic foreign object to generate heat. In such a case, the terminal voltage of the feeding coil 11 falls in a short period of time as indicated by the period from the time T34 to the time T35.

In this embodiment, at the time T35, the OFF-period determination section 71 included in the heating prevention section 70 determines whether or not the toff period during which the drive transistor 31 becomes the OFF state is equal to or less than, for example, the toffMIN period. In this timing chart, the toff period is equal to or less than the toffMIN period as a result of the determination, and hence the OFF-period determination section 71 outputs, for example, the L state as an output signal. Then, the long-term timer section 72 included in the heating prevention section 70 sets the output Q3 to the L state for an oscillation stop period based on the output signal (L state) output from the OFF-period determination section 71. In response thereto, the AND circuit 43 outputs the L state to the gate terminal of the drive transistor 31, to thereby stop the oscillation.

Next, at the time T37, the toff period becomes equal to or more than the toffMAX period until the rise of the terminal voltage of the feeding coil 11, and the OFF-signal generation section 60 outputs the H state to the output Q2. However, the long-term timer section 72 outputs the L state, and hence the gate voltage of the drive transistor 31 is maintained to the L state. As a result, the drive transistor 31 becomes the OFF state so as to extend the toff period by the predetermined oscillation stop period. The terminal voltage of the feeding coil 11 converges to the voltage Vcc of the power supply VCC while the oscillation is stopped.

Then, at the time T38, the long-term timer section 72 reaches the oscillation stop period, and sets the output Q3 to the H state. In response thereto, the AND circuit 43 outputs the H state to the gate terminal of the drive transistor 31, to thereby restart the oscillation (ton period). In other words, because the OFF-signal generation section 60 outputs the H state to the output Q2, the AND circuit 43 outputs the H state to the gate terminal of the drive transistor 31, and the ton period from the time T38 to the time T39 is started.

In this manner, when a metallic foreign object such as a coin is placed on the feeding coil 11, the power feeding device 1b according to this embodiment stops the oscillation for a given period (oscillation stop period) by the heating prevention section 70, to thereby perform intermittent oscillation.

As described above, the electronic component 30b according to this embodiment includes the drive control section 40b, and the drive control section 40b includes the OFF-period determination section 71 and the long-term timer section 72. The OFF-period determination section 71 determines whether or not the toff period (fourth period) during which the drive transistor 31 is set to the OFF state by the ON-signal generation section 50 is equal to or less than a predetermined given threshold period (toffMIN period). When it is determined by the OFF-period determination section 71 that the toff period is equal to or less than the toffMIN period, the long-term timer section 72 generates a control signal for controlling the drive transistor 31 to the OFF state for a predetermined oscillation stop period (fifth period).

With this configuration, the electronic component 30b according to this embodiment performs intermittent oscillation, for example, when a metallic foreign object such as a coin is placed on the feeding coil 11, and hence the heat generation can be reduced. Besides, the electronic component 30b according to this embodiment stops the oscillation only for a predetermined oscillation stop period and restarts the oscillation after the oscillation stop period, and hence can feed power to the power receiving device 2 immediately after a metallic foreign object is removed.

Similarly to the electronic component 30b, the power feeding device 1b and the power feeding system 100b according to this embodiment can perform intermittent oscillation, for example, when a metallic foreign object such as a coin is placed on the feeding coil 11, and hence the heat generation can be reduced.

Next, a fourth embodiment according to the present invention is described below with reference to the accompanying drawings.

### Fourth Embodiment

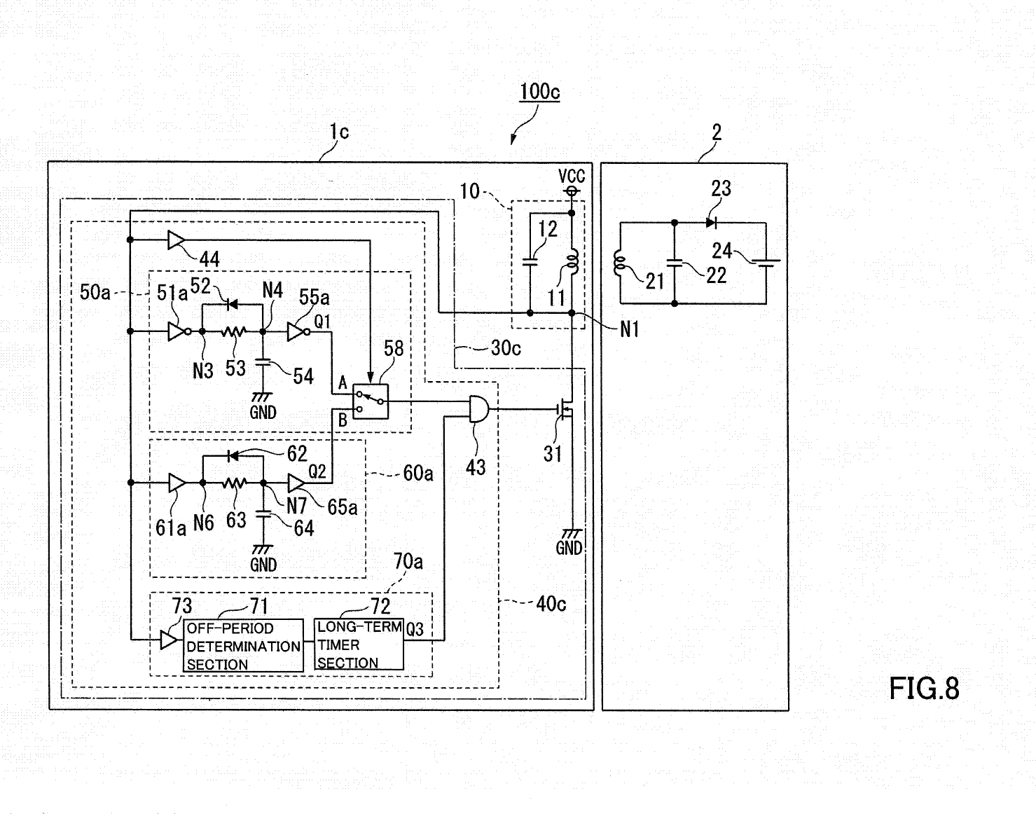

FIG. 8 is a schematic block diagram illustrating an exemplary power feeding system 100c according to the fourth embodiment of the present invention. In FIG. 8, the same configurations as in FIG. 6 are denoted by the same reference symbols, and descriptions thereof are omitted.

Referring to FIG. 8, the power feeding system 100c includes a power feeding device 1c and a power receiving device 2. The power feeding system 100c is a system for supplying electric power from the power feeding device 1c to the power receiving device 2 by wireless (in a contactless manner). For example, the power feeding system 100c supplies electric power for charging a battery 24 included in the power receiving device 2 from the power feeding device 1c to the power receiving device 2.

The power feeding device 1c includes a feeding coil 11, a resonant capacitor 12, and an electronic component 30c. The electronic component 30c includes a drive transistor 31 and a drive control section 40c. The drive control section 40c includes an AND circuit 43, a buffer 44, an ON-signal generation section 50a, an OFF-signal generation section 60a, and a heating prevention section 70a.

This embodiment is different from the third embodiment in that the ON-signal generation section 50a and the OFF-signal generation section 60a use an output in the logic state of the H state or the L state instead of the open collector output and that the level shifter function implemented by the resistor 41 and the resistor 42 in the first embodiment is included in the ON-signal generation section 50a, the OFF-signal generation section 60a, and the heating prevention section 70a. The configurations different from those in the second embodiment are described below.

The ON-signal generation section 50a includes an inverter 51a, a diode 52, a resistor 53, a capacitor 54, an inverter 55a, and a selection switch section 58, and is the same as the ON-signal generation section 50 of the third embodiment except that the inverter 51a, the inverter 55a, and the selection switch section 58 are provided.

The inverter 51a is an inverter output circuit that internally has a level shifter function implemented by resistive voltage division and outputs a signal obtained by logically inverting an input signal. The inverter 51a has an input terminal connected to the node N1 and an output terminal connected to the node N3.

The inverter 55a is, for example, an inverter output circuit for outputting a signal obtained by logically inverting an input signal, and has an input terminal connected to the node N4 and an output terminal connected to a terminal A of the selection switch section 58.

The selection switch section 58 is, for example, a selector circuit for selecting and outputting an input of its terminal A or an input of its terminal B based on a control signal. The selection switch section 58 inputs the terminal voltage of the feeding coil 11 (voltage at the node N1) as the control signal via the buffer 44 having the level shifter function, and outputs the input of the terminal A or the input of the terminal B to the AND circuit 43. When the output of the buffer 44 is in the H state, the selection switch section 58 selects and outputs the input signal of the terminal B (signal Q2). When the output of the buffer 44 is in the L state, the selection switch section 58 selects and outputs the input signal of the terminal A (signal Q1).

The OFF-signal generation section 60a includes a buffer 61a, a diode 62, a resistor 63, a capacitor 64, and an inverter 65a, and is the same as the OFF-signal generation section 60 of the third embodiment except that the buffer 61a and the buffer 65a are provided.

The buffer 61a is an output circuit that internally has a level shifter function implemented by resistive voltage division and outputs a logic signal equal to an input signal. The buffer 61a has an input terminal connected to the node N1 and an output terminal connected to the node N6.

The buffer 65a is an output circuit for outputting a logic signal equal to an input signal. The buffer 65a has an input terminal connected to the node N7 and an output terminal connected to the terminal B of the selection switch section 58.

The heating prevention section 70a includes a buffer 73, an OFF-period determination section 71, and a long-term timer section 72, and is the same as the heating prevention section 70 of the third embodiment except that the buffer 73 is provided. The buffer 73 is a buffer circuit having a level shifter function.

Next, the operation of the power feeding system 100c according to this embodiment is described below.

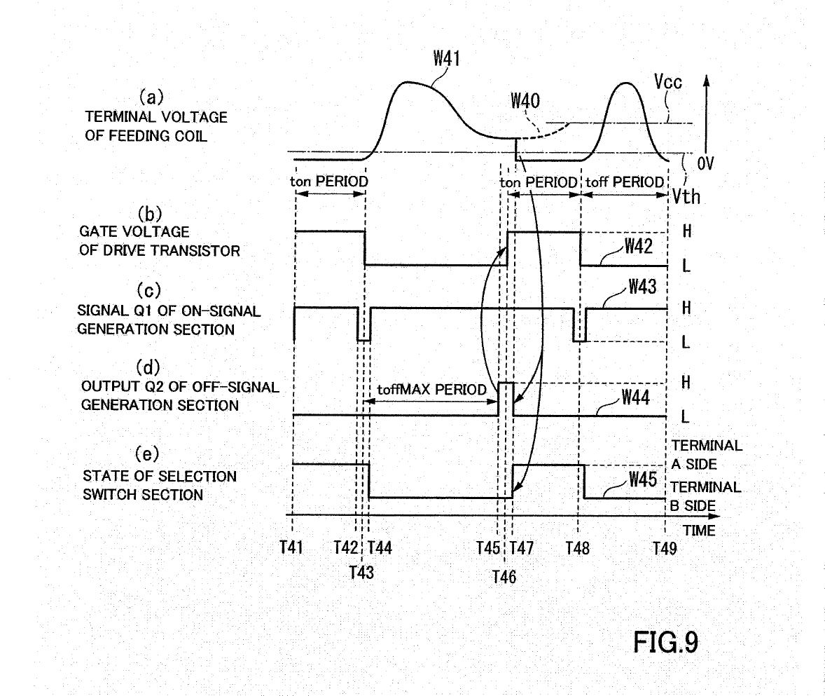

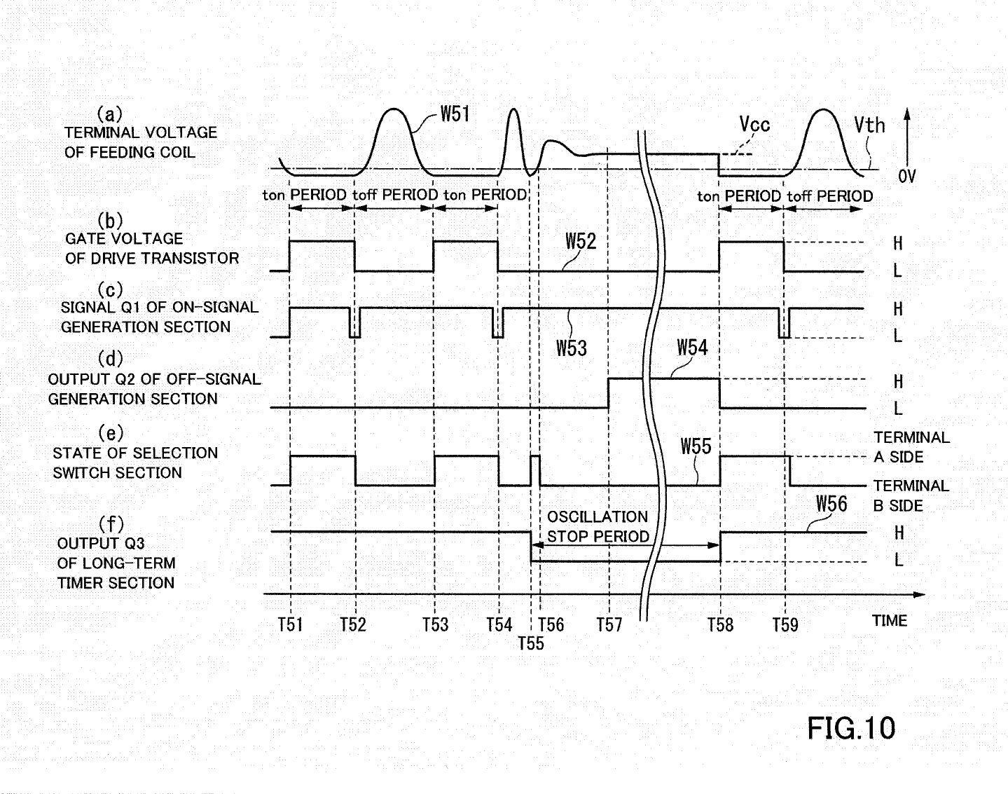

First, the operation of the power feeding device 1c included in the power feeding system 100c is described with reference to FIG. 9 and FIG. 10.

FIG. 9 is a timing chart illustrating an exemplary operation of the power feeding device 1c according to this embodiment. The timing chart of FIG. 9 illustrates an exemplary operation of the power feeding device 1c in the case where an abrupt load fluctuation occurs in the power receiving device 2.

In FIG. 9, waveforms W41 to W45 represent, in order from the top, the waveforms of (a) the terminal voltage of the feeding coil (voltage at the node N1), (b) the gate voltage of the drive transistor 31, (c) the signal Q1 of the ON-signal generation section 50a, (d) the output Q2 of the OFF-signal generation section 60a, and (e) the state of the selection switch section 58. For comparison, a waveform W40 represents the waveform of the terminal voltage of the feeding coil 11 (voltage at the node N1) obtained when the OFF-signal generation section 60a is not provided.

The vertical axes of the respective waveforms represent the voltage in (a), the terminal A side (Q1)/terminal B side (Q2) state in (e), and the logic state in (b) to (d). The horizontal axis represents time. A voltage Vth is a threshold voltage for operating the ON-signal generation section 50a and the OFF-signal generation section 60a.

The operation of the power feeding device 1c illustrated in FIG. 9 is the same as the operation of the power feeding device 1a illustrated in FIG. 5 except that the state of the control transistor 57 is replaced by the state of the selection switch section 58, and hence the description thereof is omitted. In FIG. 9, times T41 to T49 correspond to the times T21 to T29 of FIG. 5.

FIG. 10 is a timing chart illustrating another exemplary operation of the power feeding device 1c according to this embodiment. Similarly to FIG. 7, the timing chart of FIG. 10 illustrates an exemplary operation of the power feeding device 1c in the case where a user of the power feeding system 100c places a metallic foreign object such as a coin on the feeding coil 11 by mistake.

In FIG. 10, waveforms W51 to W56 represent, in order from the top, the waveforms of (a) the terminal voltage of the feeding coil (voltage at the node N1), (b) the gate voltage of the drive transistor 31, (c) the signal Q1 of the ON-signal generation section 50a, (d) the output Q2 of the OFF-signal generation section 60a, (e) the state of the selection switch section 58, and (f) the output Q3 of the long-term timer section 72. The vertical axes of the respective waveforms represent the voltage in (a), the terminal A side (Q1)/terminal B side (Q2) state in (e), and the logic state in (b) to (d) and (f). The horizontal axis represents time. A voltage Vth is a threshold voltage for operating the ON-signal generation section 50a and the OFF-signal generation section 60a.

In FIG. 10, the period from a time T51 to a time T52, the period from a time T53 to a time T54, and the period from a time T58 to a time T59 each correspond to the ton period. The period from the time T52 to the time T53 and the period after the time T59 each correspond to a toff period.

The operation of the power feeding device 1c illustrated in FIG. 10 is the same as the operation of the power feeding device 1b illustrated in FIG. 7 except that the state of the control transistor 57 is replaced by the state of the selection switch section 58, and hence the description thereof is omitted. In FIG. 10, times T51 to T59 correspond to the times T31 to T39 of FIG. 7.

As described above, the electronic component 30c, the power feeding device 1c, and the power feeding system 100c according to this embodiment include the selection switch section 58, and the drive transistor 31 is controlled by the connection of the normal logic output instead of the connection of the open collector output described in the third embodiment. Consequently, the electronic component 30c, the power feeding device 1c, and the power feeding system 100c according to this embodiment can perform the same operations as those in the third embodiment, and hence exhibit the same effects as those in the third embodiment.

Note that, the present invention is not limited to each of the above-mentioned embodiments, and may be changed within the range not departing from the concept of the present invention.

For example, in each of the above-mentioned embodiments, the drive transistor 31 uses an NMOS transistor, but may use a P-channel MOS transistor (PMOS transistor). In this case, the PMOS transistor is connected in series to the resonant circuit 10 on the power supply VCC side, and the drive control section 40 (40a to 40c) is configured to perform control with inverted logics.

In the above-mentioned fourth embodiment, the connection of the normal logic output is used instead of the connection of the open collector output described in the third embodiment, but this modification may be applied to the first and second embodiments similarly.

In the above-mentioned first to third embodiments, the connection of an open drain output may be used instead of the connection of the open collector output.

In each of the above-mentioned embodiments, the level shifter function is provided for each configuration of inputting the terminal voltage of the feeding coil 11, but the level shifter function may not be provided in the case where the withstand voltage of the circuit element is higher than the terminal voltage of the feeding coil 11.

In each of the above-mentioned embodiments, the ON-signal generation section 50 (50a), the OFF-signal generation section 60 (60a), and the heating prevention section 70 (70a) generate the respective control timing signals (Q1, Q2, Q3) by using the time constant of the resistor and the capacitor, but the present invention is not limited thereto. For example, the ON-signal generation section 50 (50a), the OFF-signal generation section 60 (60a), and the heating prevention section 70 (70a) may generate the respective control timing signals (Q1, Q2, Q3) by using a timer circuit using a given clock signal.

In each of the above-mentioned first to third embodiments, the ON-signal generation section 50 is configured to include the control transistor 57, but the ON-signal generation section 50 may not include the control transistor 57.

In each of the above-mentioned embodiments, the electronic component 30 (30a to 30c) is configured not to include the drive transistor 31, but the electronic component 30 (30a to 30c) may include the drive transistor 31.

In each of the above-mentioned embodiments, the power feeding system 100 (100a to 100c) supplies electric power for charging the battery 24 of the power receiving device 2 as an example, but the present invention is not limited thereto. For example, the power feeding system 100 (100a to 100c) may supply electric power for operating the power receiving device 2 or a device connected to the power receiving device 2.

The electronic component 30 (30a to 30c) or each configuration included in the electronic component 30 (30a to 30c) may be implemented by dedicated hardware. The electronic component 30 (30a to 30c) or each configuration included in the electronic component 30 (30a to 30c) may be constructed by a memory and a CPU, and its functions may be implemented by loading a program for implementing the electronic component 30 (30a to 30c) or each configuration included in the electronic component 30 (30a to 30c) onto the memory and executing the program.

What is claimed is:

1. An electronic component, comprising:
a switching element to be connected in series to a resonant circuit, the resonant circuit comprising a feeding coil for feeding power to a receiving coil and a resonant capacitor configured to resonate with the feeding coil; and
a drive control section for controlling the switching element,
the drive control section comprising a first signal generation section for generating, when a potential difference across the switching element falls within a given threshold range, a control signal for controlling the switching element to a conductive state for a predetermined first period and thereafter controlling the switching element to a non-conductive state.

2. An electronic component according to claim 1, wherein the drive control section further comprises a second signal generation section for generating, when the potential difference across the switching element falls outside the given threshold range, a control signal for controlling the switching element to the conductive state after a predetermined second period elapses.

3. An electronic component according to claim 2, wherein the second period is determined to be longer than a third period during which the potential difference across the switching element changes to be outside the given threshold range and returns within the given threshold range again by the resonant circuit.

4. An electronic component according to claim 3, wherein the second period is determined in consideration of a fluctuation amount of the third period corresponding to a fluctuation in a load connected to the receiving coil.

5. An electronic component according to claim 3, wherein the second period is determined in consideration of a fluctuation amount of the third period corresponding to a fluctuation in inductance due to coupling between the feeding coil and the receiving coil.

6. An electronic component according to claim 4, wherein the second period is determined in consideration of a fluctuation amount of the third period corresponding to a fluctuation in inductance due to coupling between the feeding coil and the receiving coil.

7. An electronic component according to claim 2, wherein the first period and the second period are determined based on a resonant frequency of the resonant circuit.

8. An electronic component according to claim 3, wherein the first period and the second period are determined based on a resonant frequency of the resonant circuit.

9. An electronic component according to claim 4, wherein the first period and the second period are determined based on a resonant frequency of the resonant circuit.

10. An electronic component according to claim 5, wherein the first period and the second period are determined based on a resonant frequency of the resonant circuit.

11. An electronic component according to claim 6, wherein the first period and the second period are determined based on a resonant frequency of the resonant circuit.

12. An electronic component according to claim 2, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

13. An electronic component according to claim 3, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

14. An electronic component according to claim 4, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

15. An electronic component according to claim 5, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

16. An electronic component according to claims 6, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

17. An electronic component according to claim 7, wherein:
the first signal generation section and the second signal generation section each comprise a resistor and a capacitor; and
the first signal generation section generates the first period based on a time constant of the resistor and the capacitor included therein, and the second signal generation section generates the second period based on a time constant of the resistor and the capacitor included therein.

18. An electronic component according to claim 1, wherein the drive control section further comprises:
a determination section for determining whether or not a fourth period during which the switching element becomes the non-conductive state is equal to or less than a predetermined given threshold period; and
a third signal generation section for generating, when the determination section determines that the fourth period is equal to or less than the given threshold period, a control signal for controlling the switching element to the non-conductive state for a predetermined fifth period.

19. A power feeding device, comprising:
the electronic component according to claim 1; and
a resonant circuit comprising a feeding coil and a resonant capacitor.

20. A power feeding system, comprising:
the power feeding device according to claim 19; and
a power receiving device comprising a receiving coil arranged to be opposed to a feeding coil.
